(19) United States
(12) Patent Application Publication
(10) Pub. No.: US 2025/0219132 A1
(43) Pub. Date: Jul. 3, 2025

(54) SOLID ELECTROLYTE FILM, PREPARATION METHOD AND USE THEREOF, AND SOLID STATE BATTERY

(71) Applicant: SVOLT ENERGY TECHNOLOGY CO., LTD., CHANGZHOU (CN)

(72) Inventors: SHAOJIE CHEN, CHANGZHOU (CN); RUIJIE LI, CHANGZHOU (CN); JINGCHAO LIU, CHANGZHOU (CN); LEI WANG, CHANGZHOU (CN); HAIQIANG HUANG, CHANGZHOU (CN)

(73) Assignee: SVOLT ENERGY TECHNOLOGY CO., LTD., CHANGZHOU (CN)

(21) Appl. No.: 18/885,593

(22) Filed: Sep. 14, 2024

Related U.S. Application Data
(63) Continuation of application No. PCT/CN2023/143291, filed on Dec. 29, 2023.

(30) Foreign Application Priority Data
Dec. 30, 2023 (CN) 202211741996.2

(51) Int. Cl. H01M 10/0562; H01M 4/02; H01M 4/38

(52) U.S. Cl. CPC H01M 10/0562; H01M 4/382; H01M 2004/027; H01M 2300/0068

(57) ABSTRACT

The present application relates to the technical field of battery materials, in particular to a solid state electrolyte film, preparation method and use thereof and solid state battery. The solid electrolyte film includes a lithium metal stable layer, a lithium dendrite inhibition layer and a high-conductivity layer that are stacked in sequence; in particular, the lithium metal stable layer contains a first sulfide solid electrolyte, and a surface of the first sulfide solid electrolyte is coated with a lithium sulfide protective layer; the lithium dendrite inhibition layer contains a second sulfide solid electrolyte, and the lithium dendrite inhibition layer has a porosity of less than 8%; the high-conductivity layer contains a third sulfide solid electrolyte, the third sulfide solid electrolyte has a Hinckley crystallinity index of greater than 1.1, and a particle size of greater than 20 μm.

### CROSS-REFERENCE OF RELATED APPLICATION

This application is a continuation of international PCT application serial no. PCT/CN2023/143291, filed on Dec. 29, 2023, which claims the priority to Chinese patent application No. 202211741996.2, entitled “solid electrolyte film, preparation method and use thereof, and solid state battery”, filed to China National Intellectual Property Administration on Dec. 30, 2022. The entireties of the above patent applications are hereby incorporated by reference herein and made a part of this specification.

### TECHNICAL FIELD

The invention relates to the technical field of battery materials, in particular to a solid state electrolyte film, preparation method and use thereof and solid state battery.

### BACKGROUND

Compared with liquid state batteries, the safety of the solid state batteries has been greatly improved due to the replacement of flammable organic liquid electrolytes with non-flammable solid electrolytes. At the same time, the solid state batteries can better adapt to high-energy positive and negative electrodes and reduce the system weight, with higher energy density. Therefore, the solid state batteries have received extensive attention from relevant personnel in the industry.

Among various solid state electrolyte systems, sulfide solid state electrolytes have broad application prospects due to their high processability and high ionic conductivity. When used as the negative electrode of the solid state batteries, lithium metal has the advantages such as high specific capacity, abundant resources, low density, and low cost. However, the sulfide solid electrolytes are unstable to lithium metal, and there are gaps between particles in the electrolyte film prepared from sulfide solid electrolyte particles, and lithium dendrites easily penetrate these gaps and cause short circuits in the battery. Therefore, the adaptability between the sulfide solid electrolytes and the Lithium metal negative electrode is extremely low.

At present, in order to improve the adaptability of the sulfide solid electrolyte and the lithium metal negative electrode, a usually adopted method is to introduce a third component into the sulfide solid electrolyte and the lithium metal negative electrode, for example: (i) use of a polymer electrolyte to isolate the lithium metal negative electrode and the lithium metal negative electrode and the sulfide solid electrolyte, which avoids direct contact of the lithium metal negative electrode with the sulfide solid electrolyte, thereby inhibiting the reaction between the lithium metal negative electrode and the sulfide solid electrolyte, and the relatively dense polymer electrolyte layer can also inhibit the growth of lithium dendrites; (ii) use of inorganic substances to modify the surface of the lithium metal negative electrode.

However, when a third component is introduced for improving the adaptability between the sulfide solid state electrolyte and the lithium metal negative electrode, the following problems will arise to different degrees: (i) the conductivity of the third component is usually low, resulting in a decrease in the overall conductivity of the system; (ii) after the introduction of the third component, due to the differences in material strength and mechanical properties, the interface contact between the third component and the sulfide solid electrolyte film is poor; and (iii) the stability between the third component and the sulfide solid electrolyte film is difficult to be guaranteed.

### SUMMARY

Therefore, the technical problem to be solved by the present application is that the third component has a low conductivity, the interface contact between the third component and the sulfide solid electrolyte film is poor, and the stability between the third component and the sulfide solid electrolyte is difficult to be guaranteed. The present application provides a solid electrolyte film, preparation method and use thereof and solid state battery.

When the sulfide solid electrolyte is used to prepare a solid state battery with lithium metal as the negative electrode, the potential of the contact surface between the sulfide solid electrolyte and lithium metal is 0 V, and the high-valence elements in the sulfide solid electrolyte will be reduced at this potential, resulting in the structure of the electrolyte itself collapse, thus forming a mixture product with ion conduction and electron conduction functions, which will cause a significant decrease in the ion conductivity of the electrolyte, and macroscopically exhibits an increase of the battery polarization, and a significant decrease in the charge and discharge capacity. In addition, the sulfide solid electrolyte film is composed of sulfide solid electrolyte particles, there are gaps between the particles, and lithium dendrites are easy to grow in the gaps. When the lithium dendrites grow to penetrate the entire electrolyte film, it will cause short-circuiting of the positive and negative electrodes, which will lead to an internal short circuit in the battery, and macroscopically exhibits a sudden decrease of the battery voltage and loses of the ability to charge and discharge.

In order to solve the above problems, the present application provides a solid electrolyte film, including a lithium metal stable layer, a lithium dendrite inhibition layer and a high-conductivity layer that are stacked in sequence; in particular,
the lithium metal stable layer contains a first sulfide solid electrolyte, and a surface of the first sulfide solid electrolyte is coated with a lithium sulfide protective layer;
the lithium dendrite inhibition layer contains a second sulfide solid electrolyte, and the lithium dendrite inhibition layer has a porosity of less than 8%;
the high-conductivity layer contains a third sulfide solid electrolyte, the third sulfide solid electrolyte has a Hinckley crystallinity index of greater than 1.1, and a particle size of greater than 20 μm.

Alternatively, a molar ratio of the first sulfide solid electrolyte to the lithium sulfide is 1:(0.01-0.05);
alternatively, the first sulfide solid electrolyte has a particle size of less than 5 μm;
alternatively, the lithium metal stable layer further contains a first binder, and the first binder is 1% to 5% by weight of the first sulfide solid electrolyte;
alternatively, the first binder does not contain a fluorinated group;
alternatively, the first binder includes at least one of styrene-butadiene rubber, nitrile rubber, polyethylene and polypropylene.

Alternatively, the second sulfide solid electrolyte has a Hinckley crystallinity index of 0.8-1, and a particle size of less than 0.5 μm;
alternatively, the lithium dendrite inhibition layer further contains a second binder, and the second binder is 2% to 6% by weight of the second sulfide solid electrolyte;
alternatively, the second binder includes at least one of polyvinylidene fluoride, polytetrafluoroethylene, polyisoprene, nitrile rubber and styrene-butadiene rubber.

Alternatively, the third sulfide solid electrolyte has a conductivity of greater than 7 mS/cm;
alternatively, the high-conductivity layer further contains a third binder, and the third binder is 0.5-1.5% by weight of the third sulfide solid electrolyte;
alternatively, the third binder includes at least one of polytetrafluoroethylene, polyvinylidene fluoride, polybutylene and polyethylene oxide.

Alternatively, the thicknesses of the lithium metal stable layer, the lithium dendrite inhibition layer and the high-conductivity layer can be varied within a certain range, for example, the thickness of the lithium metal stable layer may be 10-20 μm, the thickness of the lithium dendrite inhibition layer may be 10-20 μm, and the thickness of the high-conductivity layer may be 10-20 μm.

Alternatively, the first sulfide solid electrolyte, the second sulfide solid electrolyte and the third sulfide solid electrolyte can be selected within a certain range, for example, the chemical formulas of the first sulfide solid electrolyte, the second sulfide solid electrolyte and the third sulfide solid electrolyte may be Li_{3.15}P_{0.5}S_{2.5}C_{10.65}.

The present application further provides a preparation method for the above solid electrolyte film, including the following steps:
contacting and reacting the first sulfide solid electrolyte with lithium powder, and forming a film by a dry process from an obtained product to obtain a lithium metal stable layer;
making the second sulfide solid electrolyte into an electrolyte slurry with a solid content of greater than 70%, coating the electrolyte slurry on a carrier, and drying to obtain a lithium dendrite inhibition layer adhered to the carrier;
forming a film by a dry process from the third sulfide solid electrolyte to obtain the high-conductivity layer, in particular, the third sulfide solid electrolyte has a Hinckley crystallinity index of greater than 1.1, and a particle size of greater than 20 μm; and
pressing the lithium metal stable layer, the lithium dendrite inhibition layer and the high-conductivity layer together to obtain the solid electrolyte film.

Alternatively, a preparation process for the first sulfide solid electrolyte includes:
taking a raw material of the sulfide solid electrolyte, sintering at 400-500° C. for 10-15 hours, and grinding an obtained sintered material until a particle size is less than 5 μm, to obtain the first sulfide solid electrolyte;
alternatively, contacting and reacting the first sulfide solid electrolyte with lithium powder, and forming a film by a dry process from an obtained product to obtain a lithium metal stable layer includes:
mixing the first sulfide solid electrolyte with the lithium powder in a molar ratio of 1:(0.01-0.05), and ball milling at a speed of 150-200 rpm for 4-8 hours to obtain the first lithium sulfide solid electrolyte coated with the lithium sulfide protective layer;
mixing the first sulfide solid electrolyte coated with the lithium sulfide protective layer with the first binder and performing a fibrillation treatment, and pressing an obtained powder into a film to obtain the lithium metal stable layer.

In the preparation process of the lithium metal stable layer, after mixing the first sulfide solid electrolyte with lithium powder, since the lithium powder is soft, it can be uniformly coated on the surface of the sulfide solid electrolyte, and a uniform reduction reaction occurs on the surface of the sulfide solid electrolyte in contact with the lithium powder, to form a lithium sulfide protective layer. By ball milling and controlling the contact amount between the sulfide solid electrolyte and lithium metal, the lithium metal can uniformly contact with the sulfide solid electrolyte, so that the lithium sulfide protective layer can be controllably and uniformly coated on the surface of the sulfide solid electrolyte, thereby avoiding further interfacial deterioration between the sulfide solid electrolyte and lithium metal.

In addition, the film-forming process adopts a dry process, which can avoid a reduction of electrolyte stability caused by the contact of the protected sulfide solid electrolyte with organic solvents; the use of the first binder without fluorinated groups can avoid binder deterioration and failure caused by direct contact with lithium metal; and fiberization treatment can effectively improve the adhesion of the first binder.

Alternatively, a preparation process for the second sulfide solid electrolyte includes:
taking a raw material of the sulfide solid electrolyte and sintering at 260-350° C. for 5-8 hours, grinding an obtained sintered material until a particle size is less than 5 μm, to obtain the second sulfide solid electrolyte;
alternatively, making the second sulfide solid electrolyte into an electrolyte slurry with a solid content of greater than 70%, coating the electrolyte slurry on a carrier, and drying to obtain a lithium dendrite inhibition layer adhered to the carrier include:
mixing the second sulfide solid electrolyte with a solvent, and wet grinding until a particle size of the second sulfide solid electrolyte is less than 0.5 μm to obtain a second sulfide solid electrolyte dispersion;
dispersing the second binder in the second sulfide solid electrolyte dispersion to prepare an electrolyte slurry with a solid content of greater than 70%;
coating the electrolyte slurry on the carrier and drying to obtain the lithium dendrite inhibition layer adhered to the carrier.

In the preparation process of the second sulfide solid electrolyte, the low-temperature, short-time sintering process is adopted, which on the one hand can avoid the growth of crystal particles, and on the other hand can reduce the crystallinity of the second sulfide solid electrolyte, so that the particle powder of the second sulfide solid state electrolyte is softer, which is conducive to the formation of a densified lithium dendrite inhibition layer and increases the flatness of the lithium dendrite inhibition layer.

In the process of preparing the lithium dendrite inhibition layer, a wet grinding is performed to the second sulfide solid electrolyte first can effectively reduce the particle size of the electrolyte powder and maintain the uniformity of the particle sizes, thereby significantly reducing the gap between the particles in the lithium dendrite inhibition layer. Controlling the solid content of the electrolyte slurry to be greater than 70% can significantly improve the compactness of the prepared lithium dendrite inhibition layer. Alternatively, the carrier may be a release film, which can improve the flatness of the lithium dendrite inhibition layer.

Alternatively, a preparation process for the third sulfide solid electrolyte includes:
taking a raw material of the sulfide solid electrolyte and sintering at 550-630° C. for 15-20 hours, grinding an obtained sintered material until a particle size is greater than 20 μm, to obtain the third sulfide solid electrolyte;
alternatively, forming a film by a dry process from the third sulfide solid electrolyte to obtain a high-conductivity layer includes:
performing a fibrillation treatment to the third binder to obtain a fibrillated third binder;
mixing the fibrillated third binder with the third sulfide solid electrolyte, and pressing an obtained powder into a film to obtain the high-conductivity layer.

In the process of preparing the third sulfide solid electrolyte, high temperature and long-term sintering process is adopted, which can significantly increase the crystallinity and crystal particle size of the electrolyte particles, thereby improving the conductivity of the electrolyte. Controlling the particle size to be greater than 20 μm during grinding may avoid destroying the crystals by the grinding process, resulting in a smaller crystal size that affects the conductivity of the electrolyte.

In the process of preparing the high-conductivity layer, the film-forming process adopts a dry process, which on one hand can avoid external machinery such as ball mills from pulverizing the electrolyte particles, and on the other hand can avoid the decrease in conductivity caused by the contact between the sulfide solid electrolyte and the organic solvent. In the traditional film forming process by dry process, the binder is mixed with the electrolyte particles and then fibrillated to make the binder have adhesion. In the above method, the third binder is first fibrillated, and then mixed with the third sulfide solid electrolyte, which can effectively avoid the particle size reduction caused by pulverizing the third sulfide solid electrolyte particles during the fibrillation treatment process, thereby ensuring that a high-conductivity layer containing large particle size electrolyte particles can be prepared to ensure a high conductivity of the high-conductivity layer.

Alternatively, before preparing the first sulfide solid electrolyte, the second sulfide solid electrolyte and the third sulfide solid electrolyte, it may also include a step of ball milling the raw materials of the sulfide solid electrolyte. In particular, the ball milling may be performed by a planetary ball mill, with a speed of 500-700 rpm, for a milling period of 10-30 h.

Alternatively, the raw material for forming the sulfide solid electrolyte can be selected within a certain range, for example, the raw material for forming the sulfide solid electrolyte can include LiCl, Li₂S, P₂S₅. In particular, a molar ratio of LiCl, Li₂S, and P₂S₅ may be 2.6:5:1.

Alternatively, pressing the lithium metal stable layer, the lithium dendrite inhibition layer and the high-conductivity layer together to obtain the solid electrolyte film includes:
bonding non-carrier contact surfaces of the high-conductivity layer and the lithium dendrite inhibition layer, and pressing them under a pressure of 300-500 MPa for 10-30 minutes to obtain an intermediate product adhered to the carrier;
removing the carrier, and bonding a carrier contact surface of the intermediate product to the lithium metal stable layer, and pressing to obtain the solid electrolyte film.

In the above process of preparing the solid electrolyte film, the high-conductivity layer and the lithium dendrite inhibition layer are pressed together under a pressure of 300-500 MPa for 10-30 minutes, which can further densify the lithium dendrite inhibition layer and ensure that the porosity of the lithium dendrite inhibition layer is less than 8%.

The present application further provides use of the above solid electrolyte film in the preparation of a solid state battery, and the solid state battery uses lithium metal as a negative electrode.

The present application further provides a solid state battery, the solid state battery includes the above solid state electrolyte film and a lithium metal negative electrode.

The technical solution of the present application has the following advantages:

The solid electrolyte film provided by the present application includes a lithium metal stable layer, a lithium dendrite inhibition layer, and a high-conductivity layer stacked in sequence, and the above three functional layers are all made of a single sulfide solid electrolyte component, which effectively overcomes the technical problem that the third component has a low conductivity, the interface contact between the third component and the sulfide solid electrolyte film is poor, and the stability between the third component and the sulfide solid electrolyte is difficult to be guaranteed, after introducing the technical problem.

Specifically, the lithium metal stable layer contains a first sulfide solid electrolyte, the surface of the first sulfide solid electrolyte is coated with a lithium sulfide protective layer, and the lithium sulfide protective layer can effectively prevent the sulfide solid electrolyte from interacting with lithium metal negative electrode, thereby improving the stability of the sulfide solid electrolyte film to the lithium metal negative electrode.

The lithium dendrite inhibition layer contains a second sulfide solid electrolyte, and the porosity of the lithium dendrite inhibition layer is less than 8%, so the compactness of the lithium dendrite inhibition layer is high, which can effectively prevent lithium dendrites from growing between the electrolyte particles, thereby improving the ability of the electrolyte film to inhibit lithium dendrites, and effectively inhibiting the growth of lithium dendrites.

The high-conductivity layer contains a third sulfide solid electrolyte, the Hinckley crystallinity index of the third sulfide solid electrolyte is greater than 1.1, and the particle size is greater than 20 μm. By controlling higher crystallinity and particle size of the third sulfide solid electrolyte, the conductivity of the high-conductivity layer is significantly improved, so that the solid electrolyte film of the present application can maintain a high conductivity of the sulfide itself.

Therefore, the solid electrolyte film of the present application uses a single component sulfide as the electrolyte without introducing a third component, which significantly improves the stability of the sulfide solid electrolyte film to the lithium metal negative electrode, and improves the ability of inhibiting the lithium dendrites by the electrolyte film. And the high conductivity of the sulfide itself is maintained, which can effectively improve the cycle performance and rate performance of the sulfide solid electrolyte-lithium metal negative electrode solid state battery.

### BRIEF DESCRIPTION OF THE DRAWINGS

In order to more clearly illustrate the specific embodiments of the present application or the technical solutions in the related art, the accompanying drawings that need to be used in the specific embodiments or description of the related art will be briefly introduced hereinafter. Obviously, the accompanying drawings described below show some implementations of the present application, and other drawings based on these drawings can be obtained by those skilled in the art without any creative work.

FIG. 1 is the scanning electron microscope result of the lithium metal stable layer prepared in step (1) of Example 1 of the present application;

FIG. 2 is the scanning electron microscope result of the intermediate product prepared in step (4) of Example 1 of the present application;

FIG. 3 is a schematic structural view of the solid electrolyte film prepared in Example 1 of the present application.

### DETAILED DESCRIPTION OF PREFERRED EMBODIMENTS

The following examples are provided for further understanding the present application better, which are not limited to the best embodiment, and do not limit the content and protection scope of the present application. Any product identical or similar to the present application obtained by combining features of the present application and other related art or under the inspiration of the present application by anyone falls within the protection scope of the present application.

Where specific experimental procedures or conditions are not specified in the embodiments, they may be performed according to the operations or conditions of the conventional experimental procedures described in the literature in the field. Where the reagent or instrument used is not indicated for the manufacturer, they are conventional reagent product that are commercially available.

### Example 1

The solid electrolyte film was prepared as follows:
(1) Preparation of the lithium metal stable layer:
(i) LiCl, Li₂S, and P₂S₅ were mixed in a molar ratio of 2.6:5:1 by a planetary ball mill at 550 rpm for 20 hours to obtain raw materials of the sulfide solid electrolyte;
(ii) the above raw materials of the sulfide solid electrolyte were sintered at 460° C. for 12 hours, and the sintered material were ground until the particle size of the powder was less than 5 μm, to obtain the first sulfide solid electrolyte;
(iii) the above first sulfide solid electrolyte was mixed with lithium powder in a molar ratio of 1:0.02 by a planetary ball mill at a speed of 160 rpm for 6 hours to obtain the first sulfide solid electrolyte coated with a lithium sulfide protective layer;
(iv) 10 g of the above first sulfide solid electrolyte coated with lithium sulfide protective layer and 0.2 g of styrene-butadiene rubber were mixed, and applied an external shear force with a grinder to perform fiberization treatment after the mixing, then the fibrillated powder was pressed by a roller press, to obtain the lithium metal stable layer;

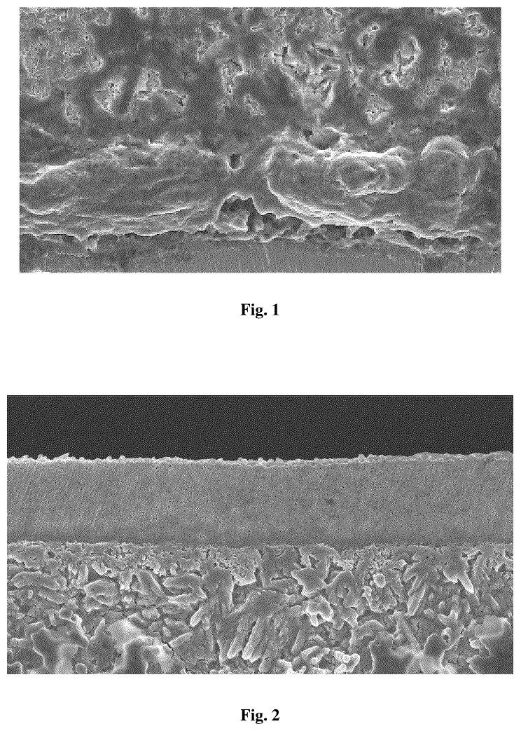

After testing, in the lithium metal stable layer prepared in this step, the chemical formula of the sulfide solid electrolyte was Li_{3.15}P_{0.5}S_{2.5}Cl_{0.65}. The lithium metal stable layer was scanned by a scanning electron microscope, and the result was shown in FIG. 1. It can be seen from FIG. 1 that the surface of the electrolyte particles in the lithium metal stable layer was evenly coated with a lithium sulfide protective layer. After calculation, the molar ratio of the first sulfide solid electrolyte to lithium sulfide was 1:0.02.
(2) Preparation of lithium dendrite inhibition layer:
(i) LiCl, Li₂S, and P₂S₅ were mixed in a molar ratio of 2.6:5:1 by a planetary ball mill at 550 rpm for 20 hours to obtain raw materials of the sulfide solid electrolyte;
(ii) the above raw materials of the sulfide solid electrolyte were sintered at 280° C. for 6 hours, and the sintered material were ground until the particle size of the powder was less than 5 μm, to obtain the second sulfide solid electrolyte;
(iii) the above second sulfide solid electrolyte was mixed with the solvent toluene, and wet ground with a pot mill until the particle size of the second sulfide solid electrolyte was less than 0.5 μm, to obtain the second sulfide solid electrolyte dispersion;
(iv) polyvinylidene fluoride was dissolved in the second sulfide solid electrolyte dispersion obtained in step (iii), in particular, the amount of polyvinylidene fluoride was 2% of the amount of the second sulfide solid electrolyte. Electrolyte slurry with a solid content of 73% was obtained after dispersing by a pot mill;
(v) the above electrolyte slurry was coated on the release film with a coating thickness of 15 μm, and dried to obtain a lithium dendrite inhibition layer adhered to the release film.

After testing, in the lithium dendrite inhibition layer prepared in this step, the chemical formula of the sulfide solid electrolyte was Li_{3.15}P_{0.5}S_{2.5}Cl_{0.65}, and the Hinckley crystallinity index of the sulfide solid electrolyte was 0.86.
(3) Preparation of high-conductivity layer:
(i) LiCl, Li₂S, and P₂S₅ were mixed in a molar ratio of 2.6:5:1 by a planetary ball mill at 550 rpm for 20 hours to obtain raw materials of the sulfide solid electrolyte;
(ii) the above raw materials of the sulfide solid electrolyte were sintered at 570° C. for 18 hours, and the sintered material were ground until the particle size of the powder was greater than 20 μm, to obtain the third sulfide solid electrolyte. The Hinckley crystallinity index was determined to be 1.21, and the conductivity was 7.6 mS/cm;
(iii) polytetrafluoroethylene was performed a fibrillation treatment by using an airflow grinder make it have adhesion, to obtain the fibrillated polytetrafluoroethylene;
(iv) 10 g of the above third sulfide solid electrolyte and 0.05 g of fibrillated polytetrafluoroethylene were mixed mechanically with a mixer, and then the mixed powder was pressed by a roller press, to obtain the high-conductivity layer.

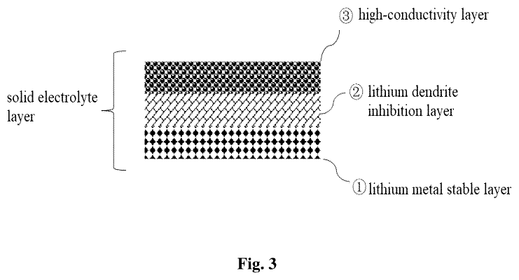

After testing, in the high-conductivity layer prepared in this step, the chemical formula of the sulfide solid electrolyte is Li_{3.15}P_{0.5}S_{2.5}Cl_{0.65}.
(4) Preparation of the solid electrolyte film:
(i) the high-conductivity layer prepared in step (3) was attached to the non-release film contact surface of the lithium dendrite inhibition layer prepared in step (2), and the two were pressed under an pressure of 420 Mpa for 20 minutes to obtain an intermediate product adhered on the release film;
the intermediate product prepared in this step was scanned by scanning electron microscope, the result is as shown in FIG. 2. As can be seen from FIG. 2, the size of the electrolyte particles in the upper lithium dendrite inhibition layer was significantly smaller, and the contact between the particles was tight, and the porosity was 6%, which can inhibit the growth of lithium dendrites. While the particle size of the electrolyte particles in the lower high-conductivity layer is large, which is conducive to the transmission of lithium ions and the improvement of crystallinity, thus has a high conductivity;
(ii) the release film attached to the intermediate product was peeled off, and the release film contact surface of the intermediate product after peeling off the release film was attached to the lithium metal stable layer prepared in step (1), and the two was pressed with a roller press, to obtain a solid electrolyte film.

The solid electrolyte film prepared in this example was shown in FIG. 3, and consisted of a lithium metal stable layer, a lithium dendrite inhibition layer, and a high-conductivity layer stacked in sequence, with a total thickness of 50 μm. In particular, the thickness of the high-conductivity layer was 20 μm, the thickness of the lithium dendrite inhibition layer was 10 μm, and the thickness of the lithium metal stable layer was 20 m.

### Example 2

The solid electrolyte film was prepared according to the method of Example 1, the difference was that when preparing the lithium metal stable layer in step (1) of this example, in operation (ii), the temperature for sintering was 400° C., and the period for sintering was 15 hours; in operation (iii), the molar ratio of the first sulfide solid electrolyte to lithium powder was 1:0.01; in operation (iv), the amount of the first sulfide solid electrolyte was 10 g, and the amount of styrene-butadiene rubber was 0.5 g.

In the solid electrolyte film prepared in this example, the molar ratio of the first sulfide solid electrolyte to lithium sulfide in the lithium metal stable layer was 1:0.01.

### Example 3

The solid electrolyte film was prepared according to the method of Example 1, the difference was that when preparing the lithium metal stable layer in step (1) of this example, in operation (ii), the temperature for sintering was 500° C., and the period for sintering was 10 hours; in operation (iii), the molar ratio of the first sulfide solid electrolyte to lithium powder was 1:0.05; in operation (iv), the amount of the first sulfide solid electrolyte was 10 g, and the amount of styrene-butadiene rubber was 0.1 g.

In the solid electrolyte film prepared in this example, the molar ratio of the first sulfide solid electrolyte to lithium sulfide in the lithium metal stable layer was 1:0.05.

### Example 4

The solid electrolyte film was prepared according to the method of Example 1, the difference was that when preparing the lithium dendrite inhibition layer in step (2) of this example, in operation (ii), the temperature for sintering was 260° C., and the period for sintering was 8 hours; in operation (iv), the amount of polyvinylidene fluoride was 3% of the amount of the second sulfide solid electrolyte, and the solid content of the electrolyte slurry after dispersion was 71%.

In the solid electrolyte film prepared in this example, the porosity of the lithium dendrite inhibition layer was 5%, and the crystallinity of the sulfide solid electrolyte was 0.81.

### Example 5

The solid electrolyte film was prepared according to the method of Example 1, the difference was that when preparing the lithium dendrite inhibition layer in step (2) of this example, in operation (ii), the temperature for sintering was 350° C., and the period for sintering was 5 hours; in operation (iv), the amount of polyvinylidene fluoride was 6% of the amount of the second sulfide solid electrolyte, and the solid content of the electrolyte slurry after dispersion was 70%.

In the solid electrolyte film prepared in this example, the porosity of the lithium dendrite inhibition layer was 6%, and the crystallinity of the sulfide solid electrolyte was 0.86.

### Example 6

The solid electrolyte film was prepared according to the method of Example 1, the difference was that when preparing the high-conductivity layer in step (3) of this example, in operation (ii), the temperature for sintering was 550° C., and the period for sintering was 20 hours; in operation (iv), the amount of the third sulfide solid electrolyte was 10 g, and the amount of the fibrillated polytetrafluoroethylene was 0.1 g.

In the solid electrolyte film prepared in this example, the Hinckley crystallinity index of the sulfide solid electrolyte in the high-conductivity layer was 1.15, and the conductivity was 7.2 mS/cm.

### Example 7

The solid electrolyte film was prepared according to the method of Example 1, the difference was that when preparing the high-conductivity layer in step (3) of this example, in operation (ii), the temperature for sintering was 630° C., and the period for sintering was 15 hours; in operation (iv), the amount of the third sulfide solid electrolyte was 10 g, and the amount of the fibrillated polytetrafluoroethylene was 0.06 g.

In the solid electrolyte film prepared in this example, the crystallinity of the sulfide solid electrolyte in the high-conductivity layer was 1.32, and the conductivity was 7.9 mS/cm.

### Comparative Example 1

The solid electrolyte film was prepared as follows:
(1) LiCl, Li₂S, and P₂S₅ were mixed in a molar ratio of 2.6:5:1 by a planetary ball mill at 550 rpm for 20 hours to obtain raw materials of the sulfide solid electrolyte;
(2) the above raw materials of the sulfide solid electrolyte were sintered at 460° C. for 12 hours, and the sintered material were ground until the particle size of the powder was less than 5 μm, to obtain the sulfide solid electrolyte;
(3) the above first sulfide solid electrolyte was mixed with lithium powder in a molar ratio of 1:0.02 by a planetary ball mill at a speed of 160 rpm for 6 hours to obtain the first sulfide solid electrolyte coated with a lithium sulfide protective layer;
(4) 10 g of the above first sulfide solid electrolyte coated with lithium sulfide protective layer and 0.2 g of styrene-butadiene rubber were mixed, and applied an external shear force with a grinder to perform fiberization treatment after the mixing, then the fibrillated powder was pressed by a roller press, to obtain the solid electrolyte film.

### Comparative Example 2

The solid electrolyte film was prepared as follows:
(1) LiCl, Li₂S, and P₂S₅ were mixed in a molar ratio of 2.6:5:1 by a planetary ball mill at 550 rpm for 20 hours to obtain raw materials of the sulfide solid electrolyte;
(2) the above raw materials of the sulfide solid electrolyte were sintered at 280° C. for 6 hours, and the sintered material were ground until the particle size of the powder was less than 5 μm, to obtain the sulfide solid electrolyte;
(3) the above sulfide solid electrolyte was mixed with the solvent toluene, and wet ground with a pot mill until the particle size of the second sulfide solid electrolyte was less than 0.5 μm, to obtain the second sulfide solid electrolyte dispersion;
(4) polyvinylidene fluoride was dissolved in the sulfide solid electrolyte dispersion obtained in step (3), in particular, the amount of polyvinylidene fluoride was 2% of the amount of the second sulfide solid electrolyte. Electrolyte slurry with a solid content of 73% was obtained after dispersing by a pot mill;
(5) the above electrolyte slurry was coated on the release film with a coating thickness of 90 μm, and dried to obtain the solid electrolyte film with a thickness of 50 μm.

### Comparative Example 3

The solid electrolyte film was prepared as follows:
(1) LiCl, Li₂S, and P₂S₅ were mixed in a molar ratio of 2.6:5:1 by a planetary ball mill at 550 rpm for 20 hours to obtain raw materials of the sulfide solid electrolyte;
(2) the above raw materials of the sulfide solid electrolyte were sintered at 570° C. for 18 hours, and the sintered material were ground until the particle size of the powder was greater than 20 μm, to obtain the third sulfide solid electrolyte. The Hinckley crystallinity index was determined to be 1.21, and the conductivity was 7.6 mS/cm;
(3) polytetrafluoroethylene was performed a fibrillation treatment by using an airflow grinder make it have adhesion, to obtain the fibrillated polytetrafluoroethylene;
(4) 10 g of the above sulfide solid electrolyte and 0.05 g of fibrillated polytetrafluoroethylene were mixed mechanically with a mixer, and then the mixed powder was pressed by a roller press, to obtain the solid electrolyte film with a thickness of 50 μm.

### Comparative Example 4

The solid electrolyte film was prepared as follows:
(1) a lithium metal stable layer with a thickness of 25 μm was prepared according to the method of step (1) in Example 1, and a lithium dendrite inhibition layer with a thickness of 25 μm was prepared according to the method of step (2) in Example 1;
(2) the release film attached to the above lithium dendrite inhibition layer was peeled off, and the release film contact surface of the lithium dendrite inhibition layer after peeling off the release film was attached to the above lithium metal stable layer, and the two were pressed by a roller press, to obtain a solid electrolyte film with a thickness of 50 μm.

### Comparative Example 5

The solid electrolyte film was prepared as follows:
(1) a lithium metal stable layer with a thickness of 25 μm was prepared according to the method of step (1) in Example 1, and a high-conductivity layer with a thickness of m was prepared according to the method of step (3) in Example 1;
(2) the above lithium metal stable layer was attached to the above high-conductivity layer, and the two were pressed by a roller press to obtain a solid electrolyte film with a thickness of 50 μm.

### Comparative Example 6

The solid electrolyte film was prepared as follows:
(1) a lithium dendrite inhibition layer with a thickness of 25 μm was prepared according to the method of step (2) in Example 1, and a high-conductivity layer with a thickness of 25 μm was prepared according to the method of step (3) in Example 1;
(2) the above high-conductivity layer was attached to the non-release film contact surface of the lithium dendrite inhibition layer, and the two were pressed under an pressure of 420 Mpa for 20 minutes to obtain a solid electrolyte film with a thickness of 50 μm.

### Experimental Example

The solid electrolyte films prepared in Examples 1-7 and Comparative Examples 1-6 were used to prepare all-solid state batteries, and the preparation method was as follows:
the positive electrode active material NCM811, the solid electrolyte Li6PS5Cl, the binder polyvinylidene fluoride, and the conductive carbon SP were mixed in a mass ratio of 60:30:5:5 to obtain a positive electrode slurry, and then the positive electrode slurry was coated on the surface of the aluminum foil, to obtain the positive electrode; the lithium metal sheet was used as the negative electrode; the positive electrode, the solid electrolyte film, and the negative electrode were assembled into an all-solid state battery according to the conventional method.

Each of the all-solid state batteries was tested by using the charge and discharge test system for the rate performance, at 0.33 C, 1 C, and 4 C rates. The test method was as follows:
(1) 0.33 C discharge specific capacity: using the LanDian test equipment, the battery was charged with a constant current of 0.33 C, the charge cut-off voltage was 4.2V, the battery was discharged with a constant current at the same current, and the discharge cut-off voltage was 3V;
(2) 1 C discharge specific capacity: using the LanDian test equipment, the battery was charged with a constant current of 1 C, the charge cut-off voltage was 4.2V, the battery was discharged with a constant current at the same current, and the discharge cut-off voltage was 3V;
(3) 4 C discharge specific capacity: using the LanDian test equipment, the battery was charged with a constant current of 4 C, the charge cut-off voltage was 4.2V, the battery was discharged with a constant current at the same current, and the discharge cut-off voltage was 3V,
(4) 4 C/0.33 C retention rate: 4 C discharge specific capacity/0.33 C discharge specific capacity;
(5) 50-cycle retention rate: using the LanDian test equipment, the battery was charged with a constant current of 1 C, the charge cut-off voltage was 4.2V, the battery was discharged with a constant current at the same current, the discharge cut-off voltage was 3V, and the cycle was 50 cycles.

The test results are shown in Table 1.

TABLE 1
Rate performance test results of all-solid state batteries

| | Discharge specific | | | 4 C/0.33 C | 50-cycle |
|---|---|---|---|---|---|
| | capacity (mAh/g) | | | retention | retention |
| | 0.33 C | 1 C | 4 C | rate | rate |
| Example 1 | 214.4 | 197.2 | 181.1 | 84.5% | 93.5% |
| Example 2 | 214.0 | 194.8 | 181.3 | 84.7% | 93.4% |
| Example 3 | 214.5 | 194.5 | 184.9 | 86.2% | 93.8% |
| Example 4 | 214.3 | 197.7 | 185.2 | 86.4% | 93.7% |
| Example 5 | 213.6 | 197.2 | 184.1 | 86.2% | 94.2% |
| Example 6 | 214.7 | 198.2 | 183.8 | 85.6% | 92.3% |
| Example 7 | 211.7 | 199.3 | 182.3 | 86.1% | 93.4% |
| Comparative | 201.6 | 175.8 | 144.3 | 71.6% | / |
| example 1 | | | | | |
| Comparative | 205.3 | 181.5 | 145.1 | 70.7% | 62.3% |
| example 2 | | | | | |
| Comparative | During the first cycle, a short circuit was | | | | |
| example 3 | caused by the punctures of lithium dendrites | | | | |
| Comparative | 206.3 | 182.1 | 151.8 | 73.6% | 87.5% |
| example 4 | | | | | |
| Comparative | 204.3 | 183.5 | 159.7 | 78.2% | / |
| example 5 | | | | | |
| Comparative | 206.2 | 184.4 | 154.8 | 75.1% | 42.6% |
| example 6 | | | | | |

The solid state electrolyte film of Comparative Example 1 was prepared into an all-solid state battery. After cycling for 23 weeks, the lithium dendrites inside the battery pierced the solid state electrolyte film, causing a short circuit. This is because the solid state electrolyte film only contains a lithium metal stable layer and does not contain a lithium dendrite inhibition layer.

The solid state electrolyte film of Comparative Example 2 was prepared into an all-solid state battery. The retention rate after 50 cycles was 62.3%, which was far lower than 93.5% in Example 1, this is because the sulfide solid state electrolyte in the solid state electrolyte layer of Comparative Example 2 reacts with the lithium metal negative electrode, leading to a collapse of the structure of the electrolyte itself, forming a mixed product of ionic and electronic conduction, resulting in a significant decrease in the ionic conductivity of the electrolyte, which eventually exhibits an increase in battery polarization, a significant decrease in charge and discharge capacity, and a rapid decline in battery capacity.

The solid state electrolyte film of Comparative Example 3 was prepared into an all-solid state battery, and lithium dendrites pierced the solid state electrolyte film in the first cycle, causing a short circuit in the battery. This is because the solid electrolyte layer contains only high-conductivity layer, the particle size of the electrolyte in the high-conductivity layer is large, and the gap between the particles is large, which leads to the short circuit of the battery caused by the easy growth of lithium dendrites in the gap.

The solid state electrolyte film of Comparative Example 4 was prepared into an all-solid state battery, and the 4 C/0.33 C capacity retention rate was 73.6%, significantly lower than 84.5% in Example 1, because the solid state electrolyte film prepared in Comparative Example 4 did not have a high-conductivity layer, resulting in lower conductivity than that of the solid electrolyte film prepared in Example 1, resulting in a poor rate performance.

The solid state electrolyte film of Comparative Example 5 was made into an all-solid state battery. After cycling for 11 weeks, the lithium dendrites inside the battery pierced the solid state electrolyte film, causing a short circuit, which was caused by the absence of a lithium dendrite inhibition layer in the solid state electrolyte film.

The solid state electrolyte film of Comparative Example 6 was prepared into an all-solid state battery, and the retention rate after 50 cycles was 42.6%, which was far lower than 93.5% in Example 1, this is because there was no lithium metal stable layer in the solid state electrolyte layer of Comparative Example 6. The sulfide solid electrolyte reacts with the lithium metal negative electrode, causing a collapse of the structure of the electrolyte itself, forming a mixed product of ionic and electronic conduction, resulting in a significant decrease in the ionic conductivity of the electrolyte, which eventually exhibits an increase in battery polarization, a significant decrease in charge and discharge capacity, and a rapid decline in battery capacity.

Apparently, the above embodiments are only examples for clear description, rather than limit to the embodiments. For those of ordinary skill in the art, other modifications or changes in different forms can be made on the basis of the above description. It is not necessary and impossible to exhaustively list all the embodiments here. And the obvious modifications or changes derived therefrom are still within the protection scope of the present application.

What is claimed is:

1. A solid electrolyte film, comprising a lithium metal stable layer, a lithium dendrite inhibition layer and a high-conductivity layer that are stacked in sequence; wherein,
the lithium metal stable layer contains a first sulfide solid electrolyte, and a surface of the first sulfide solid electrolyte is coated with a lithium sulfide protective layer;
the lithium dendrite inhibition layer contains a second sulfide solid electrolyte, and the lithium dendrite inhibition layer has a porosity of less than 8%;
the high-conductivity layer contains a third sulfide solid electrolyte, the third sulfide solid electrolyte has a Hinckley crystallinity index of greater than 1.1, and a particle size of greater than 20 μm.

2. The solid electrolyte film according to claim 1, wherein a molar ratio of the first sulfide solid electrolyte to the lithium sulfide is 1:(0.01-0.05).

3. The solid electrolyte film according to claim 1, wherein the first sulfide solid electrolyte has a particle size of less than 5 μm.

4. The solid electrolyte film according to claim 1, wherein the lithium metal stable layer further contains a first binder, and the first binder is 1% to 5% by weight of the first sulfide solid electrolyte.

5. The solid electrolyte film according to claim 1, wherein the first binder does not contain a fluorinated group.

6. The solid electrolyte film according to claim 1, wherein the first binder comprises at least one of styrene-butadiene rubber, nitrile rubber, polyethylene and polypropylene.

7. The solid electrolyte film according to claim 1, wherein the second sulfide solid electrolyte has a Hinckley crystallinity index of 0.8-1, and a particle size of less than 0.5 μm.

8. The solid electrolyte film according to claim 1, wherein the lithium dendrite inhibition layer further contains a second binder, and the second binder is 2% to 6% by weight of the second sulfide solid electrolyte.

9. The solid electrolyte film according to claim 1, wherein the second binder comprises at least one of polyvinylidene fluoride, polytetrafluoroethylene, polyisoprene, nitrile rubber and styrene-butadiene rubber.

10. The solid electrolyte film according to claim 1, wherein the third sulfide solid electrolyte has a conductivity of greater than 7 mS/cm.

11. The solid electrolyte film according to claim 1, wherein the third binder comprises at least one of polytetrafluoroethylene, polyvinylidene fluoride, polybutylene and polyethylene oxide.

12. The solid electrolyte film according to claim 1, wherein the third binder comprises at least one of polytetrafluoroethylene, polyvinylidene fluoride, polybutylene and polyethylene oxide.

13. A preparation method for the solid electrolyte film according to claim 1, comprising the following steps:
contacting and reacting the first sulfide solid electrolyte with lithium powder, and forming a film by a dry process from an obtained product to obtain a lithium metal stable layer;
making the second sulfide solid electrolyte into an electrolyte slurry with a solid content of greater than 70%, coating the electrolyte slurry on a carrier, and drying to obtain a lithium dendrite inhibition layer adhered to the carrier;
forming a film by a dry process from the third sulfide solid electrolyte to obtain the high-conductivity layer, wherein the third sulfide solid electrolyte has a Hinckley crystallinity index of greater than 1.1, and a particle size of greater than 20 μm; and
pressing the lithium metal stable layer, the lithium dendrite inhibition layer and the high-conductivity layer together to obtain the solid electrolyte film.

14. The preparation method according to claim 13, wherein a preparation process for the first sulfide solid electrolyte comprises:
taking a raw material of the sulfide solid electrolyte, sintering at 400-500° C. for 10-15 hours, and grinding an obtained sintered material until a particle size is less than 5 μm, to obtain the first sulfide solid electrolyte.

15. The preparation method according to claim 13, wherein contacting and reacting the first sulfide solid electrolyte with lithium powder, and forming a film by a dry process from an obtained product to obtain a lithium metal stable layer comprises:
mixing the first sulfide solid electrolyte with the lithium powder in a molar ratio of 1:(0.01-0.05), and ball milling at a speed of 150-200 rpm for 4-8 hours to obtain the first lithium sulfide solid electrolyte coated with the lithium sulfide protective layer;
mixing the first sulfide solid electrolyte coated with the lithium sulfide protective layer with the first binder and performing a fibrillation treatment, and pressing an obtained powder into a film to obtain the lithium metal stable layer.

16. The preparation method according to claim 13, wherein a preparation process for the second sulfide solid electrolyte comprises:
taking a raw material of the sulfide solid electrolyte and sintering at 260-350° C. for 5-8 hours, grinding an obtained sintered material until a particle size is less than 5 μm, to obtain the second sulfide solid electrolyte.

17. The preparation method according to claim 13, wherein making the second sulfide solid electrolyte into an electrolyte slurry with a solid content of greater than 70%, coating the electrolyte slurry on a carrier, and drying to obtain a lithium dendrite inhibition layer adhered to the carrier comprise:
mixing the second sulfide solid electrolyte with a solvent, and wet grinding until a particle size of the second sulfide solid electrolyte is less than 0.5 μm to obtain a second sulfide solid electrolyte dispersion;
dispersing the second binder in the second sulfide solid electrolyte dispersion to prepare an electrolyte slurry with a solid content of greater than 70%;
coating the electrolyte slurry on the carrier and drying to obtain the lithium dendrite inhibition layer adhered to the carrier.

18. The preparation method according to claim 13, wherein a preparation process for the third sulfide solid electrolyte comprises:
taking a raw material of the sulfide solid electrolyte and sintering at 550-630° C. for 15-20 hours, grinding an obtained sintered material until a particle size is greater than 20 μm, to obtain the third sulfide solid electrolyte.

19. The preparation method according to claim 13, wherein forming a film by a dry process from the third sulfide solid electrolyte to obtain a high-conductivity layer comprises:
performing a fibrillation treatment to the third binder to obtain a fibrillated third binder;
mixing the fibrillated third binder with the third sulfide solid electrolyte, and pressing an obtained powder into a film to obtain the high-conductivity layer.

20. A solid state battery, wherein the solid state battery comprises the solid state electrolyte film according to claim 1 and a lithium metal negative electrode.
